(19) United States
(12) Patent Application Publication
(10) Pub. No.: US 2013/0035795 A1
(43) Pub. Date: Feb. 7, 2013

(54) System And Method For Using Data Centers As Virtual Power Plants

(71) Applicants: Clemens Pfeiffer, Sunnyvale, CA (US); Peter Maltbaek, Mountain View, CA (US); Emre Kulali, Menlo Park, CA (US)

(72) Inventors: Clemens Pfeiffer, Sunnyvale, CA (US); Peter Maltbaek, Mountain View, CA (US); Emre Kulali, Menlo Park, CA (US)

(21) Appl. No.: 13/565,724

(22) Filed: Aug. 2, 2012

Related U.S. Application Data
(60) Provisional application No. 61/514,424, filed on Aug. 2, 2011.

(51) Int. Cl. G05B 13/00

(52) U.S. Cl. 700/276

(57) ABSTRACT

A system and method for using a data center as a virtual power plant are described. The data can be used to reduce energy consumption using pre-cooling and absorb excess energy generation.

### PRIORITY CLAIMS/RELATED APPLICATIONS

This application claims the benefit under 35 USC 119(e) to U.S. Provisional Patent Application No. 61/514,424, filed on Aug. 2, 2011 and entitled “System and Method for Using Data Centers as Energy Storage Devices”, the entirety of which is incorporated herein by reference.

### FIELD

The disclosure relates generally to a system and method for conserving energy and in particular to a system and method for using a data center as a “virtual power plant.”

### BACKGROUND

Utility companies are looking for ways to add least cost generation and reduce power consumption to maintain reserve margins and provide reliable electricity supply during peak load conditions. For example, during the June 2012 heat waves on the East Coast and Texas, Independent System Operators (ISOs) (PJM in the East Coast and ERCOT in Texas) were forced by necessity to pay generators over 20 times the normal price for a MWH of power during the late afternoon hours. At the same time, the ISOs and utilities were asking their customers to voluntarily reduce power consumption so they would not have to order rolling blackouts or have to buy even more expensive power on the spot market to maintain minimal reserve margins and ensure system reliability.

While the ISOs typically ask everyone including small residential consumers to reduce consumption during these peak load conditions, Data Centers potentially offer a large-scale (1-20 MW per data center) energy resource where power consumption can be rapidly adjusted during a time of electrical system stress to either reduce consumption or increase it to absorb over-generation, for instance when there is excessive wind power being produced at night. However, Data Centers must above all else maintain the quality of their application service, and so any power adjustment of the kind described must be performed in a way that does not compromise this service level in any way. It is therefore desirable to provide a system and method for enabling a data center to behave as a virtual power plant (VPP) and it is to this end that the disclosure is directed.

### BRIEF DESCRIPTION OF THE DRAWINGS

FIG. 1 illustrates an example of a data center system that incorporates a data center energy storage system;

FIG. 2 is a flowchart of a method for using a data center as an energy storage device;

FIG. 3 is chart of the power used by a pre-cooled data center as compared to energy rates; and

FIG. 4 is a chart of the temperature in a pre-cooled data center.

### DETAILED DESCRIPTION OF ONE OR MORE EMBODIMENTS

The disclosure is particularly applicable to a data center system in which pre-cooling, either of the air mass within the Data Center, or of the water reservoir if the Data Center is water-cooled, is used as a technique to “store” energy from the grid based on data center operational and thermal characteristics and it is in this context that the disclosure will be described. It will be appreciated, however, that the system and method has greater utility since the data center system may also adjust server capacity, shift loads to other sites and shut down non-critical equipment in the data center to adjust the overall energy usage of the data center.

Large data centers have unique characteristics that make them an ideal fit to become a virtual power plant (VPP.) In particular, the data center can manage electric grid power by absorbing excess power on the grid during over-generation of power and/or reduce power during peak times by storing energy in the data center system. Data centers host servers and other IT equipment that produce a lot of heat when executing instructions or even when idle. Therefore, large data centers require massive cooling capacity to eliminate heat generated by the IT equipment. On average, for every watt of power consumed by IT equipment, data centers need another watt of power to operate the equipment needed to remove the heat generated by the IT equipment. Some data centers use outside air or water that is already relatively cool to reduce the overall cooling power demand, however, they still have to use energy to completely manage the excess heat.

An energy management system that controls the data center may either absorb excess power from the grid during over-generation of power on the grid by storing power within the data center, and/or reduce power consumption from the grid during peak times by making use of the energy stored at the data center.

When the data center is used to reduce power during peak hours, the system can anticipate these events and use pre-cooling to lower the internal temperature of the Data Centers from 80 degrees F. to 60 degrees F., or the cooling water being used by an equivalent amount, during the night and early morning when energy prices are cheap, or charge batteries during the night and use power from the batteries during peak pricing or utilization events. The system then turns off the chillers and pumps during the peak load hours, letting the temperature float up to 80+ degrees F. (or the water equivalently) to either avoid paying for high cost energy if they are on a time-of-use rate or otherwise exposed to real-time energy prices, or to take large blocks of power loads off the power grid during extreme load conditions as part of a paid service (usually referred to as a “demand response program”) by the grid operator.

According to industry references, data centers should run with an IT inlet temperature that is close to 80.6 F.—however most Data Centers today run much cooler. Cooling most often happens by pumping a large amount of air through the data center. By adjusting the temperature of the air in the data center, the data center can store energy that can be leveraged at a later point in time using the system that is described in more detail now.

When the data center is used to absorb excess generation being produced by the grid that would otherwise be wasted, for instance from renewable energy such as wind, the data center energy management system runs the equipment in the data center at a higher utilization rate to use the excess energy. Thus, the data center with the data center energy management system can be used to manage the grid energy by either absorbing energy or reducing energy during peak times.

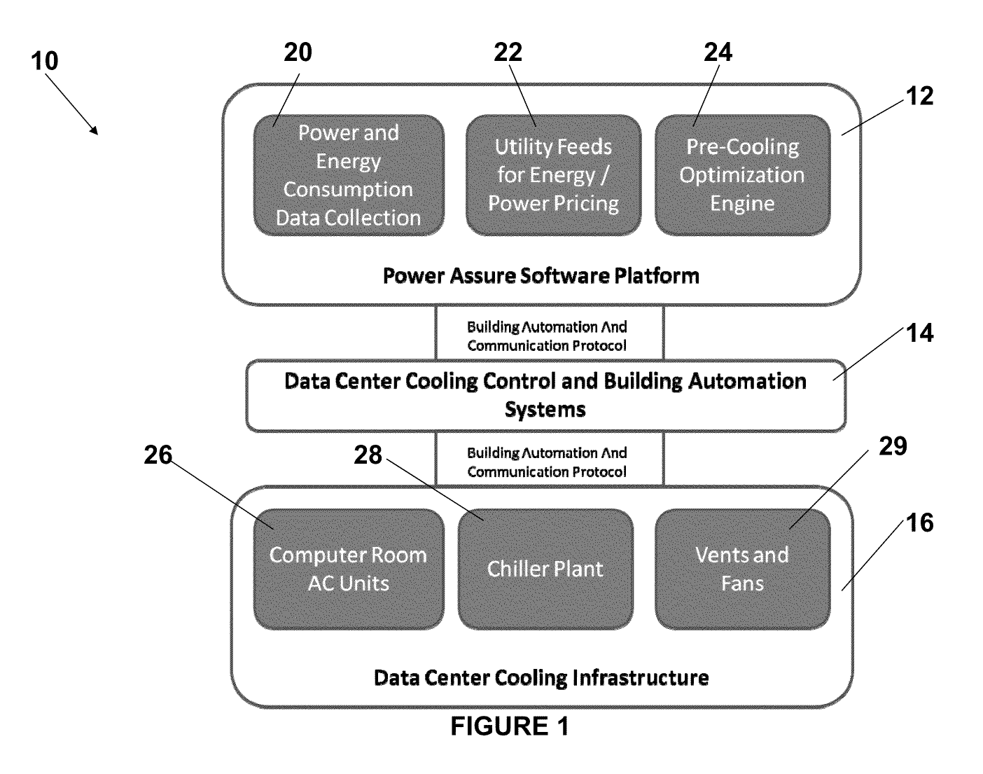

FIG. 1 illustrates an example of a data center system 10 that incorporates a data center energy management system 12. The data center system 10 has the data center energy management system 12, a data center cooling control and building automation system 14 that controls the data center operations including the cooling of the data center and a set of data center environment infrastructure 16, such as cooling infrastructure, for controlling the environment of the data center, such as cooling the data center, based on the control by the data center cooling control and building automation system 14. The data center may also have a plurality of racks of computer equipment as does any typical data center. The data center energy management system 12 communicates with the data center cooling control and building automation system 14 using common building automation and communications protocols (i.e. Modbus, BacNET, SNMP) and the data center cooling control and building automation system 14 communicates with the set of data center cooling infrastructure 16 using common building automation and communications protocols (i.e. Modbus, BacNET, SNMP).

In one implementation, the data center energy management system 12 may be one or more server computers (running in the data center for example or in a different location) that execute a plurality of lines of computer code. The data center energy management system 12 may also be implemented in hardware. The data center energy management system 12 may have a power and energy consumption data collection unit/module 20 (a software module in the software implementation or a hardware unit in the hardware implementation for each of these modules/units), a utility feeds for energy/power pricing module/unit 22 and a grid energy management unit/module 24, such as a pre-cooling optimization unit to store grid energy. The power and energy consumption data collection unit/module 20 collects the power and energy consumption of the data center, the utility feeds for energy/power pricing module/unit 22 gathers the data about the energy rates for energy (or information about the demand response program, such as when calls to reduce power will occur) at the particular data center and the data center energy management unit/module 24 determines the timing for the energy management event, such as the data center pre-cooling as described in more detail below when the data center is used to store energy and reduce load during peak times or energy absorbing for excess grid power. In a typical data center, the set of data center cooling infrastructure 16 may include computer room AC units 26, a chiller plant 28 and vents and fans 29 which are well known.

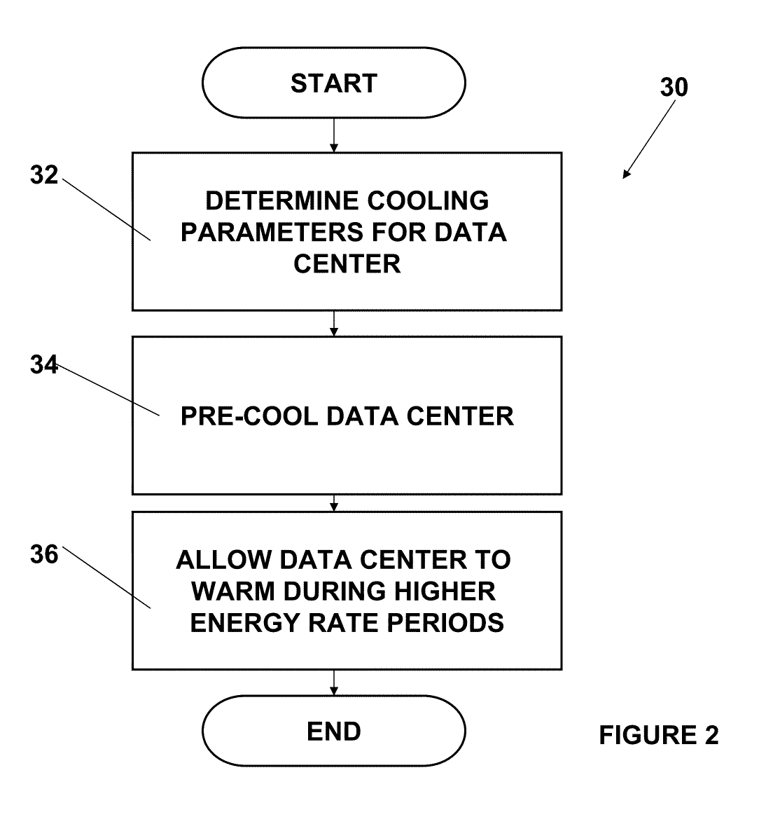

FIG. 2 is a flowchart of a method 30 for using a data center as a virtual power plant. In the method, the data center energy management system 12 determines a set of grid energy parameters for an energy management event for the data center (32) in which the parameters may be cooling parameters when the data center is reducing load and pre-cooling the data center or absorbing parameters when the data center is absorbing excess grid energy. For example, the parameters may include energy rate prices, a cost to pre-cool the data center, demand response request information, weather forecast information, price per kWh prediction information energy trading information, a wholesale electricity market and a local energy service provider energy trading purpose. Based on the energy parameters, the data center energy management unit/module 24 determines, when the data center is being pre-cooled to store grid energy and reduce load during peak times, the optimal pre-cooling to be performed and pre-cools the data center (34) using the automation system 14 and the data center cooling infrastructure 16. In addition, based on the energy parameters, the data center energy management unit/module 24 determines, when the data center is absorbing grid energy, the time during which grid energy is absorbed and which elements of the data center are going to absorb the excess grid energy.

In one implementation of the method when the data center stores energy, the data center is pre-cooled during low energy rate times and then allowed to warm up during higher energy rate times (36) which means that energy is being stored in the data center using the method by effectively using the air and metal enclosures of the data center, or the water reservoir as a storage device of energy. Thus, the data center acts as a VPP for the purpose of balancing the electrical load on the utility grid during times of high demand or times of excess generation of power.

In the one implementation described above, the “pre-cooling” can be counted as one of the techniques utilized in order to cool the data center during hours of low electricity rates. The data center is cooled to a lower operating temperature than normal. Then the pre-cooled data center is allowed to warm up slowly during peak rate hours creating energy cost savings as well as free capacity to be offered to the electrical grid or energy market place. By automating this process, driven by demand response requests, real time market pricing and power availability (the cooling parameters), organizations can create energy cost savings by participating in demand response and other utility programs. Furthermore, by measuring the time it takes to cool down a data center by 10° F. and letting it warm back up, data centers can make a certain amount of power available to the utility market for a certain period of time (usually during times of peak demand) for incentive payments.

Unlike other buildings, where people are the main beneficiary of air conditioning and cooling systems, data centers are built to host servers and Information Technology (IT) equipment. Such equipment typically generates a huge amount of heat during operation, depending on the load of the equipment at any time and is sensitive to the temperature of the air used. For example, unlike with people in an office, IT equipment in a data center can, all of a sudden, shut down when the inlet temperature exceeds a certain temperature threshold resulting in loss of capacity, data and processing, something data centers don't accept despite the potential benefits, therefore they did not participate in any such programs. Using specific IT/server forecasts and calculating power using various methods, such as the PAR4 technique disclosed in U.S. Pat. No. 7,970,561 that is incorporated herein by reference (“PAR4 technique”) and associated cooling demand allows the data center energy management system and unit to determine the appropriate time and duration of a grid energy event. When the data center is being used to store energy and reduce consumption during peak times, the data center energy management system and unit use the PAR4 technique (or other techniques) to define the amount of pre cooling required to reduce power consumption by a certain amount for a set period. Similarly, when the data center is being used to absorb excess grid power, the data center energy management system and unit use the PAR4 technique (or other techniques) to define the potential, ideal time and duration of increased power consumption to absorb the excess power.

As an example, for an IT forecast for the next 24 hours, the data center energy management system/unit converts the IT forecast into power consumption using PAR4 idle/peak values and then converts that into cooling demand (every watt used by a server requires up to 1 watt to be cooled (depending on the cooling infrastructure), which can be done through cooling equipment or outside air, outside water, which would reduce the actual power demand for cooling but not the energy removal requirement.)

With a server using 150 W idle, 300 W at peak utilization, the power consumption for an average 20% utilization over the next 24 hours would be 180 W*24 hrs—cooling demand would be an equal 180 W over 24 hours so pre cooling for 2 hours at the rate of 180 W would allow to turn off cooling for a 2 hour period later.

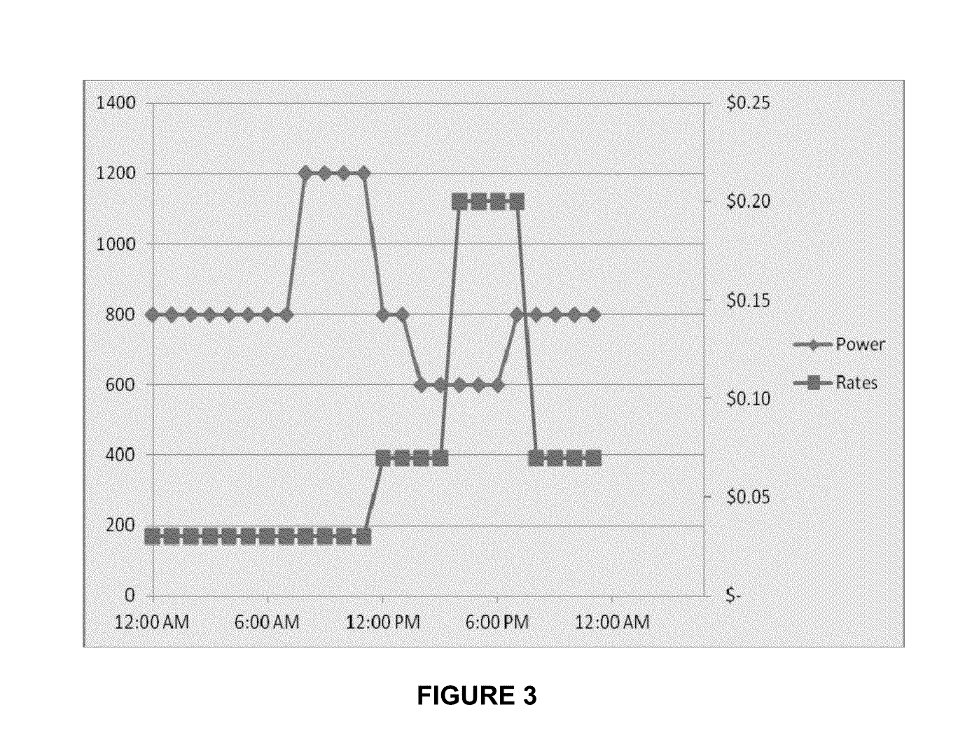

FIG. 3 is chart of the power used by a pre-cooled data center as compared to energy rates. In particular, the data center energy management module/unit 24 has determined the optimal cooling and, as shown in FIG. 3, the power for cooling is increased when rates are low (between 6 AM—noon in this example) and then it is lowered when rates increase during peak hours. In the example shown in FIG. 3, the cooling parameter is the energy rates. The cooling parameters (for adjusting cooling) may also be a weather forecast, demand response requests, market predictions and utilization patterns.

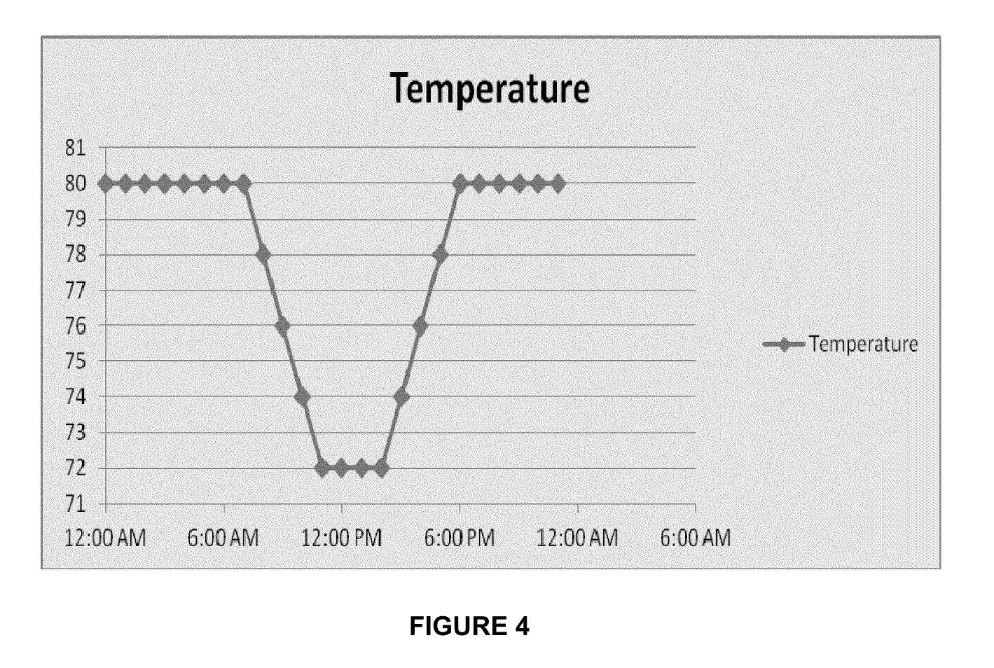

FIG. 4 is a chart of the temperature in a pre-cooled data center. In particular, FIG. 4 illustrates the temperature fluctuation observed within the data center as a function of time wherein the data center is pre-cooled before peak hours based on the cooling optimization module/unit 24.

When the cooling of the data center is shifted in time (pre-cooled), the air (or water) capacity of the data center can be used as energy storage. In particular, the data center is first cooled below its normal operating temperature by increasing the cooling system power and the temperature in the data center is then allowed to rise back up to the normal operating temperature slowly during peak rate hours by reducing the power consumption of the cooling system which means that energy is being effectively stored in the data center. The optimal cooling for the data center is determined based on the cooling parameters that may be energy rates, a demand response request, a weather forecast, a price per kWh prediction(s) and/or for energy trading purposes in the wholesale electricity markets operated by regional power markets. The data center power may also be managed using the data center energy storage system by adjusting server capacity, shifting load to other sites and shutting down non-critical equipment.

In addition to the pre-cooling described above in which the air conditioning is operated at low energy rate times, the pre-cooling may also be done by limiting the maximum power that the racks in the data center can consume thereby reducing the heat emitted and thus cooling the data center below normal. Alternatively, the pre-cooling may be performed through scheduling the operating hours of servers, storage devices and networking equipment thereby reducing the data center temperature below normal. In addition, the pre-cooling may be performed through distributing, shedding and shifting the application load of the data center to be pre-cooled to other data centers located elsewhere and thereby reducing the IT power consumption, heat and cooling the data center below normal. In addition to pre-cooling the air as described above, the concept of pre-cooling may also be used for cooling liquids, cooling of the metallic enclosures, cooling of the frames and underground liquid storage systems.

For an absorption energy management event, the data center energy management system and unit determines how the various equipment and infrastructure in the data center may be used to absorb the excess energy. For example, additional pieces of equipment may be turned on to absorb the energy or certain pieces of equipment may have their utilization increases to thereby absorb the excess grid energy.

In addition to the use of the data center as an VPP, the system may also implement a system and method for determining a pre-cooling capacity and quality of the data center that may be based on, for example, an ability to cool down fast and/or an ability to stay at a desired temperature. In the method, the data center energy management system and unit collects data from a series of tests whereby the Data Center is cooled by an extra degree in each subsequent test, and then allowed to return to normal operating temperatures. Measurements are taken of both the extra energy required to perform each degree of pre-cooling and of the time taken for the Data Center to return to normal temperature. This data is then analyzed to build a reference table for future use. In this way the additional cost of pre-cooling and the temporal response of the Data Center for each degree is established, and this information is used to determine the optimal action to take for future periods of time. The general method for rating IT equipment may be the PAR4 technique. The system may also implement a method for rating the pre-cooling capacity and quality of the data center using the same technique as described above in that the cost to pre-cool in terms of energy required is determined and recovery time constitute the “quality” of the data center.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A data center system, comprising:
a set of infrastructure that controls an environment of the data center;
a data center building automation system that controls the set of infrastructure; and
a data center energy management unit, connected to the data center building automation system, that determines a timing of an energy management event of the data center based on one or more grid energy parameters so that the data center is a virtual power plant.

2. The system of claim 1, wherein the data center energy management event is a pre-cooling of the data center and the one or more grid energy parameters are one or more cooling parameters so that the data center stores energy due to the pre-cooling and reduces energy consumption during a peak time.

3. The system of claim 1, wherein the energy management event is an energy absorption by the data center so that the data center absorbs excess grid energy.

4. The system of claim 1, wherein the one or more grid energy parameters is one of an energy rate, a cost to pre-cool, a demand response request, a weather forecast, an energy price prediction, a wholesale electricity market and a local energy service provider energy trading purpose.

5. The system of claim 1, wherein the data center energy management unit uses a forecast to determine an estimated power consumption of the set of infrastructure that defines an energy demand of the data center, a cooling requirement of the data center and a pre-cooling adjustment for a set period of power consumption reduction at a later time.

6. The system of claim 2, wherein the data center building automation system pre-cools the data center system based on the timing determination by the grid energy management unit.

7. The system of claim 2, wherein the data center energy management unit automatically determines a timing of a pre-cooling of the data center system based on one or more pre-cooling parameters so that the data center system stores energy due to the pre-cooling.

8. The system of claim 7, wherein the determined timing is a lower temperature of the data center system during a low energy price time.

9. The system of claim 7, wherein the set of infrastructure further comprises a cooler and wherein the data center building automation system pre-cools the data center system by operating the cooler during the determined timing.

10. The system of claim 9, wherein the determined timing is a lower temperature of the data center system during a low energy price time.

11. The system of claim 1 further comprising a plurality of racks of equipment that are housed in the data center system.

12. The system of claim 11, wherein the data center building automation system pre-cools the data center system by one of limiting a maximum power consumed by the plurality of racks of equipment, scheduling operating hours of the plurality of racks of equipment, distributing an application load on the data center system to a different data center system during the determined timing, cooling a liquid, cooling a metallic enclosure on the plurality of racks of equipment and using an underground liquid storage system.

13. A method for power grid energy management using a data center system having a set of infrastructure that controls an environment of the data center and a data center building automation system that controls the set of infrastructure, the method comprising:
determining, using a data center energy management unit connected to the data center building automation system, a timing of a grid energy management event of the data center based on one or more grid energy parameters; and
performing, using the data center building automation system, the grid energy management event of the data center so that the data center is a virtual power plant.

14. The method of claim 13, wherein the grid energy management event is a pre-cooling of the data center and the one or more grid energy parameters are one or more cooling parameters so that the data center stores energy due to the pre-cooling and reduces energy consumption during a peak time.

15. The method of claim 13, wherein the grid energy management event is an energy absorption by the data center so that the data center absorbs excess grid energy.

16. The method of claim 13, wherein the one or more grid energy parameters is one of an energy rate, a cost to pre-cool, a demand response request, a weather forecast, an energy price prediction, a wholesale electricity market and a local energy service provider for energy trading purposes

17. The method of claim 13 further comprising using, by the data center energy management unit, a forecast to determine an estimated power consumption of the set of infrastructure that defines an energy demand of the data center, a cooling requirement of the data center and a pre-cooling adjustment for a set period of power consumption reduction at a later time.

18. The method of claim 14, wherein performing the grid energy management event further comprises pre-cooling the data center system based on the timing determination by the data center energy management unit.

19. The method of claim 14, wherein determining the timing of the grid energy management event further comprises automatically determining a timing of a pre-cooling of the data center method based on one or more pre-cooling parameters so that the data center method stores energy due to the pre-cooling.

20. The method of claim 19, wherein the determined timing is a lower temperature of the data center method during a low energy price time.

21. The method of claim 19, wherein the determined timing is a lower temperature of the data center method during a low energy price time.

22. The method of claim 14, wherein the data center building automation method pre-cools the data center method by one of limiting a maximum power consumed by the plurality of racks of equipment, scheduling operating hours of the plurality of racks of equipment, distributing an application load on the data center method to a different data center method during the determined timing, cooling a liquid, cooling a metallic enclosure on the plurality of racks of equipment and using an underground liquid storage method.

23. A method for determining a data center rating, the method comprising:
collecting, by a data center energy management unit, data about a series of tests in which the data center is cooled by one degree and then allowed to return to a normal operating temperature; and
generating a reference table for the data center based on the data from the series of tests.

24. The method of claim 23 further comprising determining an additional cost of cooling for the data center and a time for the data center to return to the normal temperature.
